(19) United States
(12) Patent Application Publication
(10) Pub. No.: US 2026/0316355 A1
(43) Pub. Date: Oct. 15, 2026

(54) MOLD AND METHOD FOR OVERMOLDING A TABLEWARE VESSEL

(71) Applicants: Sébastien CHAUVIN, ANGLET (FR); Pierre BUSQUET, TALENCE (FR); QUIET, TALENCE (FR)

(72) Inventors: Sébastien CHAUVIN, ANGLET (FR); Pierre BUSQUET, TALENCE (FR); Benat BERHOUET, BIDARRAY (FR); Mikel GAILLARD, USTARITZ (FR); Mikel CURUTCHARRY, SAINT ETIENNE DE BAIGORRY (FR)

(21) Appl. No.: 19/485,465

(22) PCT Filed: May 17, 2024
(86) PCT No.: PCT/EP2024/063741

§ 371 Date: Nov. 18, 2025

(30) Foreign Application Priority Data
May 19, 2023 (FR) 2304977

(51) Int. Cl. B29C 45/26; B29C 45/14; B29K 709/08; B29L 31/00

(52) U.S. Cl. CPC B29C 45/2602; B29C 45/14434; B29K 2709/08; B29K 2995/007; B29L 2031/7404

(57) ABSTRACT

According to a first aspect, the invention provides a mold (10) for injection overmolding a tableware vessel (20) with a material comprising silicone, the mold (10) comprising a female part (12) and a male part (11), the female part (12) comprising:
a cavity (13) configured to accommodate a first face (21) of the tableware vessel during overmolding,
an injection nozzle (9) configured to allow the injection of the material comprising silicone into the cavity (13) over the first face (21),
   the male part comprising:
a central stud (1) formed of a material having a Shore D hardness comprised between 50 and 60 or comprising a coating of a material having a Shore D hardness comprised between 50 and 60, configured to accommodate a second face (22) of the tableware vessel,
a peripheral seal (3) formed of a material having a Shore A hardness comprised between 50 and 60, and configured to accommodate edges (23) of the tableware vessel (20), the peripheral seal extending circumferentially around the central stud,
a shaping recess (2) that extends circumferentially between the central stud (1) and the peripheral seal (3),
   wherein the shaping recess (2) and the peripheral seal (3) are suitable for allowing the edges (23) to move during overmolding.

### TECHNICAL FIELD

The present disclosure concerns the field of overmolding tableware vessels, especially overmolding food vessels with a flexible material.

### STATE OF THE ART

In collective catering facilities, such as cafeterias in schools, universities or residential facilities for the elderly, the use of tableware generates considerable noise due to shocks between different pieces of tableware. In addition to the inconvenience that this creates for users of such facilities, the noise thus generated affects the health of the employees of these facilities, who experience this noise for several hours a day at their workplace.

Indeed, studies have shown that the sound frequencies of shocks between tableware pieces can reach high values above 1.5 kHz, which are detrimental to the comfort and health of human beings. Prolonged exposure to such sound frequencies thus poses a real public health problem.

In order to reduce the noises due to these shocks, it is known to use tableware covered with a flexible material such as silicone. Two methods advantageously make it possible to manufacture two-material tableware comprising silicone. First, the tableware can be sprayed with a silicone by room-temperature vulcanizing (RTV). This method consists of spreading or spraying the malleable silicone, making it possible to cover the tableware, then the silicone is advantageously crosslinked or cured at room temperature. However, RTV silicone has a high viscosity even at room temperature and is therefore not suitable for fast and precise overmolding of tableware. In particular, when the shape of the tableware is complex, the material takes a considerable time to cover the tableware, and cannot precisely conform to its shape, and it may be necessary to post-treat the tableware after overmolding to obtain the desired finished product. Material waste is therefore generated with the accompanying undesirable pollution and production costs. In addition, the time required to crosslink RTV silicone can be up to several days, making such methods unsuitable for industrial-scale tableware production.

Another method for the manufacture of two-material tableware is the injection of liquid silicone rubber (LSR). This material has the advantage of exhibiting highly thixotropic properties, i.e., when subjected to shear stresses—as is the case during pressure injection into a mold—its viscosity decreases sharply and it is in the liquid state, allowing the material to spread rapidly while adopting the shape imposed by the mold and tableware. In addition, LSR can cross-link much faster than RTV silicone, typically in less than a minute, and thus significantly reduces the time required to overmold tableware. This type of method is carried out in a mold made of hard material, especially steel, in order to ensure that the mold does not become damaged during use, and tolerances between the mold and the fins of the vessel are avoided as far as possible.

However, for industrial-scale production, it is desirable to use tempered glass tableware, which is cheaper and much lighter than tableware made of materials such as ceramics or earthenware. Thermal tempering of the glass gives it a mechanical strength suitable for food use, but has the consequence of deforming the tableware, which in its tempered state have variations in diameter and height of up to several millimeters—i.e., it is neither perfectly round nor perfectly flat, unlike porcelain or earthenware tableware. These variations in size make tempered glass tableware unsuitable for known injection overmolding methods, for example with LSR: The tableware cracks or breaks due to the considerable pressure it undergoes during injection—which can reach up to approximately 700 bars—the pressure necessary to reduce the production cycle time of a tableware vessel as much as possible, since the injection time required changes inversely with the injection pressure. This pressure, and the associated reduction in injection time, are also necessary to prevent the silicone from crosslinking in contact with the mold, due to the high temperature of the mold.

### DISCLOSURE

One object of the present application is to propose a mold and a method for injection-overmolding a tableware vessel which are adapted to tempered glass tableware and to the irregularities in size which it presents, that is to say which allows the tableware to be overmolded without cracking.

Another object of the present application is to provide a seal between the vessel and the mold that is satisfactory for the injection of LSR, despite such irregularities in the size of the vessel.

Another object of the present application is to propose a mold and a method allowing rapid and precise overmolding of the tableware despite such dimensional irregularities.

Another object of the present application is to propose a mold and a method adapted to industrial scale production, allowing the production of silent tableware, especially for use in collective catering facilities.

To this end, the present disclosure concerns, according to a first aspect, a mold for injection-overmolding a tableware vessel with a material comprising silicone, the mold comprising a female part and a male part, the female part comprising:
a cavity configured to accommodate a first face of the tableware vessel during overmolding,
an injection nozzle configured to allow the injection of the material comprising silicone into the cavity over the first face,
   the male part comprising:
a central stud formed of a material having a Shore D hardness comprised between 50 and 60 or comprising a coating of a material having a Shore D hardness comprised between 50 and 60, configured to accommodate a second face of the tableware vessel,
a peripheral seal formed of a material having a Shore A hardness comprised between 50 and 60, and configured to accommodate the edges of the tableware vessel, the peripheral seal extending circumferentially around the central stud,
a shaping recess that extends circumferentially between the central stud and the peripheral seal,
   wherein the shaping recess and the peripheral seal are suitable for allowing the edges to move during overmolding.

Thus, the vessel is free to move sufficiently so as not to be subjected to stresses which would exceed its mechanical strength, while being supported so as to guarantee a distribution of the forces over its entire surface, thus avoiding excessively high local stresses, and by presenting a seal with the mold sufficient for the injection of liquid silicone.

According to one embodiment, the mold comprises a vacuum pump connected to a central orifice opening into a central zone of the stud so as to retain the second face on the central stud by suction.

According to one embodiment, the mold comprises a vacuum drawing system opening out into the female part facing the first face or facing the male part.

According to one embodiment, the peripheral seal and/or the central stud comprise a material having nonstick properties, such as polytetrafluoroethylene, or is/are covered with a coating comprising a material having nonstick properties, such as polytetrafluoroethylene.

According to one embodiment, the peripheral seal and/or the shaping recess is/are adapted to allow the edges to move by less than 3 millimeters, preferably between 1 and 3 millimeters, more preferably between 1 and 2 millimeters.

According to one embodiment, the mold comprises at least one pusher located in the cavity of the female part and capable of moving the vessel away from the cavity by pushing on the first face.

According to one embodiment, the at least one pusher extends over the entire circumference of the cavity.

According to a second aspect, the present disclosure relates to a method of overmolding a tableware vessel with a material comprising silicone, comprising the steps of:
a. positioning the vessel in a mold according to any of the preceding claims, a second face of the vessel being placed on the central stud and the edges of the vessel being accommodated on the peripheral seal,
b. closing the mold by bringing the female part opposite the male part so as to retain the vessel between the female part and the male part,
c. injecting the material comprising silicone through the injection nozzle until the first face is covered with the material,
d. opening the mold and removing the vessel.

According to one implementation, the method further comprises a step of drawing a vacuum in the air located between the second face and the central stud by means of a vacuum pump connected to a central orifice opening into a central zone of the stud, so as to retain the second face of the vessel on the central stud.

According to one implementation, the method further comprises a step of drawing a vacuum in the air disposed between the first face and the cavity by means of a vacuum drawing system so as to facilitate the injection of the material comprising silicone into the cavity.

According to one implementation, the method comprises, before or during the step of opening the mold, a step of moving the first face of the vessel away from the female part, implemented by actuating pushers disposed in the cavity of the female part.

According to one implementation of the method, the tableware vessel is a tempered glass vessel.

According to one implementation of the method, the vessel is a plate or a ramekin.

### DESCRIPTION OF THE FIGURES

Other characteristics, objects and advantages will emerge from the following description, which is purely illustrative and non-limiting, and which must be read with reference to the attached drawings in which:

FIG. 1 schematically illustrates a tableware vessel obtained by an overmolding method as proposed

FIG. 2 schematically illustrates a mold as proposed;

FIG. 3 schematically illustrates a method of overmolding a tableware vessel as proposed.

### DETAILED DESCRIPTION OF EMBODIMENTS

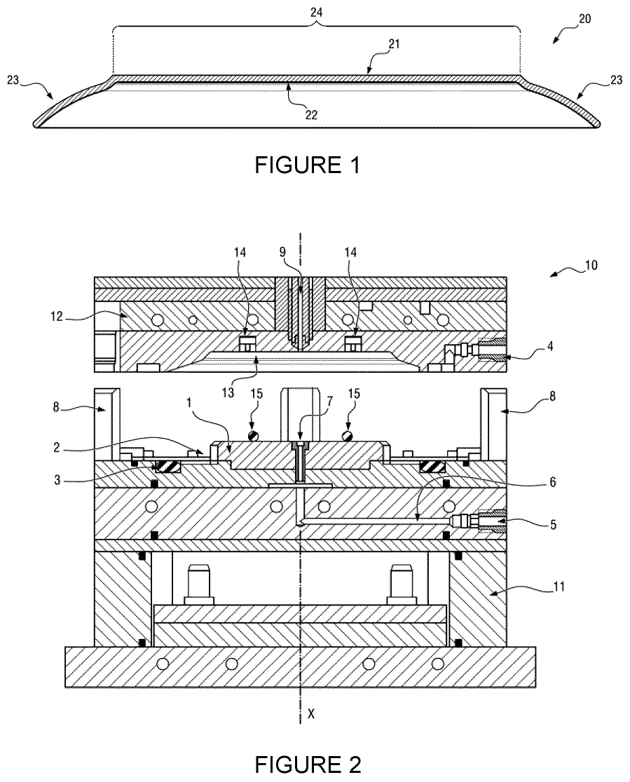

According to a first aspect, an injection overmolding mold is proposed. With reference to FIG. 1, which shows a generic tableware vessel, such a vessel 20 comprises a first face 21 intended to rest on a table or a tray and a second face 22 receiving the food placed on or in the vessel. The vessel 20 further comprises edges 23 extending circumferentially around a central portion 24. The edges 23 may extend parallel to the central part 24, for a flat plate, or may exhibit a greater or lesser angle with this central part 24. It is also possible for the central part 24 and/or the edges 23 to be at least partly curvilinear, for example in the case of a bowl or a ramekin.

The proposed mold 10 is shown in FIG. 2. It comprises a male part 11 and a female part 12. The female part 12 is provided with a cavity 13 configured to accommodate, in use, the first face 21 of the tableware vessel 20, while the male part 11 is provided with a central stud 1 configured to accommodate the second face 22 of the vessel 20.

A main axis X of the mold is defined as being an axis perpendicular to the planes formed, on the one hand, by the surface of the female part 12 on which the cavity 13 is disposed, and on the other hand by the surface of the male part 11 on which the stud 1 rests. The main axis X also passes through the respective centers of the cavity 13 and of the stud 1. Said main axis also defines the opening-closing direction of the mold.

Naturally, the shapes of the cavity and of the stud must be adapted to the geometry of the vessel 20 which it is desired to overmold. For this purpose, when it is necessary to overmold different vessel geometries, several separate molds 10 can be used.

The female part 12 comprises an injection nozzle 9 by means of which a material comprising silicone can be injected into the cavity 13 in order to cover the first face 21 with said material. The nozzle 10 is preferably disposed in the middle of the cavity 13 but may be disposed in other positions enabling it to open out into the cavity 13.

The central stud 1 of the male part 11 must be formed of a flexible material that has a sufficiently low coefficient of friction to allow movement of the vessel 20. Flexible is understood to mean a material with a Shore D hardness comprised between 50 and 60. Alternatively, the central stud 1 may be formed of a harder material, but covered with a coating with a coefficient of friction sufficiently low to allow movement of the vessel 20, and having a Shore D hardness between 50 and 60. By means of these mechanical properties, the surface of the central stud 1 can accommodate the second face 22 of the vessel 20 so as to allow movement of the vessel 20 perpendicular to the main axis X of the mold 10. Thus, the vessel 20 naturally assumes the position in which the forces due to the injection pressure are distributed over its surface, and the risk of locally concentrated forces likely to damage the vessel 20 is minimized.

The mold 10 is particularly suitable for overmolding tempered glass vessels 20, which have irregularities in size along the three axes, for the reasons mentioned above.

According to one embodiment, the central stud 1 comprises a material having nonstick properties, especially polytetrafluoroethylene—known by the brand name Teflon®. The central stud 1 may also be composed of another material covered with a nonstick coating.

On the surface of the male part 11 receiving the stud 1, a peripheral seal 3 extends along a circle centered on the main axis X, so as to be at a distance from the main axis X greater than that corresponding to the circumference of the stud 1. The function of this peripheral seal is to serve as a support for the edges 23 of the tableware vessel 20 when the vessel is disposed in the mold 10. Like the stud 1, the seal 3 is formed of a flexible material, the Shore A hardness of which is comprised between 50 and 60. In a manner similar to the stud 1, the flexibility of the peripheral seal 3 allows movement of the edges 23 of the vessel 20 during overmolding so as to ensure the best possible distribution of the forces on the surface of the vessel 20.

According to one embodiment, the peripheral seal 3 comprises a material having nonstick properties, especially polytetrafluoroethylene—known by the brand name Teflon®. The peripheral seal 3 may also be composed of another material covered with a nonstick coating. This characteristic has the advantage of preventing the edges 23 of the vessel from adhering to the peripheral seal 3, and thus of facilitating the withdrawal of the vessel 20 from the mold 10 after overmolding.

Between the stud 1 and the seal 3, the surface of the male part 11 forms a shaping recess 2, i.e., the part of the edges 23 of the vessel 20 situated between the stud 1 and the peripheral seal 3 in a direction perpendicular to the main axis X does not rest directly on the male part 11 since the shaping recess 2 is situated between this part of the edges 23 and the surface of the male part 11. The shaping recess 2 thus contributes, together with the peripheral seal 3 and the stud 1, to allowing the vessel 20 to move during overmolding.

The peripheral seal 3 and/or the shaping recess 2 may be adapted to allow movement of the edges 23 of less than 3 millimeters, preferably between 1 and 3 millimeters, and even more preferably between 1 and 2 millimeters.

The mold 10 comprises a closure system capable of moving the male part 11 and the female part 12 relative to each other. The closure system may be capable of moving the male part 11 and/or the female part 12. The closure system may especially comprise jacks, such as hydraulic or pneumatic jacks. The mold 10 may be a horizontal press mold, that is to say comprising jacks disposed horizontally, the surfaces of the male part 11 and female part 12 then extending in a vertical plane, or a vertical press mold with jacks disposed vertically, the surfaces of the male part 11 and female part 12 then extending in a horizontal plane.

The mold 10 may, according to a particular embodiment, comprise a vacuum pump 5 in order to retain the second face 22 of the vessel 20 on the central stud 1 by suction, once the plate has been positioned in the mold 10. This vacuum pump 5 is particularly suitable when the mold 10 is of the horizontal press type, since the faces 21, 22 of the vessel are then disposed in a vertical plane once they have been placed in the mold, and it is therefore necessary to ensure that the vessel 20 is pressed against the stud 1 when the mold 10 is not in the fully closed position. However, such a vacuum pump 5 can also be provided when the mold 10 is of the vertical press type.

The vacuum pump 5 is connected to an orifice 7 opening into the stud 1, preferably at the center of the stud. When the vacuum pump 5 is placed at a distance from the stud 1, a duct 6 can be provided to connect the pump 5 to the orifice 7.

Another embodiment provided for pressing the second face 22 of the vessel onto the central stud 1 comprises a bearing seal 15 disposed on the central stud. The bearing seal 15 is a circular seal centered on the main axis X and disposed on the surface of the central stud 1. This seal has adhesive properties making it possible to ensure that the second face 22 is held on the central stud 1, even when the mold 10 is of the horizontal press type.

It is possible to combine the two embodiments mentioned above and to provide a central stud 1 comprising an orifice 7 connected to a vacuum pump 5, as well as a bearing seal 15. The mold 10 may comprise a vacuum drawing system 4. Such a system opens into the female part 12 either directly opposite the first face 21 of the vessel 20 when the vessel is placed in the mold 10, or opposite the male part 11. The vacuum drawing system 4 makes it possible to reduce the pressure of the air located between the vessel 20 and the female part 12, thus facilitating the injection of silicone through the nozzle 9.

When the lower face 21 of the vessel 20 has a large surface area, there is a risk that the injected material will not only adhere to the vessel 20, but also to the cavity 13 or to the female part 12. The application of chemical substances or soapy water can make it possible to detach the injected material from the cavity 13 or the female part 12, however with mixed results. To this end, the mold comprises, according to one embodiment, one or more pushers 14 disposed in the cavity 13 and capable of moving the vessel 20 away from the cavity 13. It may be a plurality of pushers 14 or a single circular pusher centered on the main axis X and extending over the entire circumference of the cavity 13. This eliminates the need to use special products to detach the material, reducing the operating costs of the mold. Furthermore, this embodiment has the advantage of being easily automated—it suffices to actuate the pusher(s) 14 when it is necessary to separate the vessel 20 from the mold 10—and is therefore suitable for use on an industrial scale.

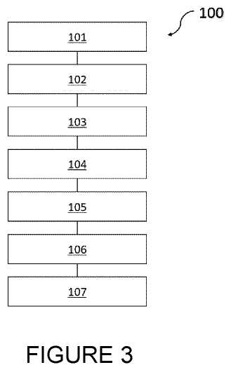

There is also proposed a method 100 for overmolding a tableware vessel 20 with a material comprising silicone, in a mold 10 as described above. With reference to FIG. 3, the method comprises, in its most general embodiment, a step 101 of positioning the vessel 20 in the mold 10, the second face 22 of the vessel 20 being placed on the central stud 1, the peripheral seal 3 receiving the edges 23 of the vessel 20. After positioning the vessel 20, a closing step 102 is implemented, according to which the female part 12 is brought opposite the male part 11 by actuating the system for closing the mold 10. The vessel is then retained between the male and female parts 11, 12 and does not move until the injection of material has begun. This is followed by a step 105 of injecting the material comprising silicone, preferably a liquid silicone gum, through the injection nozzle 9 disposed in the female part 12 so as to cover the entirety of the first face 21 with the injected material. During the injection step, the vessel 20 will be free to adopt a position which reduces the local forces, because of the particular characteristics of the mold 10 described above. Finally, a step 107 of opening the mold is implemented, allowing the vessel 20 to be withdrawn from the mold 10.

After the positioning step 101, it is not necessary for the edges 23 of the vessel 20 to reach, over the entire circumference thereof, the end of the peripheral seal 3 furthest from the main axis X. Because of the variability in the size of the vessel, the edges 23 may not reach the same position of the peripheral seal 3 over the entire circumference of the vessel 20. It will then be possible to inject a thicker layer of material at the circumferential positions where the vessel 20 has a reduced diameter, so as to obtain an overmolded vessel of substantially uniform diameter after the overmolding method 100 has been implemented.

The type of material injected via the injection nozzle 9 has a direct impact on the quality of the overmolded vessel 20 obtained. According to one embodiment, the material injected during the injection step 105 is a liquid silicone gum having self-adhesive properties. It is thus ensured that a tableware vessel 20 is obtained which has satisfactory molecular cohesion between the injected silicone and the material of which the vessel 20, before the overmolding method 100 is carried out, is made.

According to one implementation of the method, when the male part 11 of the mold 10 comprises a vacuum pump 5, a vacuum drawing step 103 is carried out before the injection step 105 so as to retain the second face 22 of the vessel 20 on the central stud 1, either after closing 102 of the mold 10, or directly after positioning 101 of the vessel 20 on the central stud 1, especially when the mold 10 is of the horizontal press type and the vessel 20 could not be held on the central stud 1 in the absence of drawing a vacuum.

According to another implementation of the method, when the female part 12 comprises a vacuum drawing system 4, the method may comprise a step 104 of creating a vacuum in the air disposed between the first face 21 and the cavity 13 by means of the vacuum drawing system 4, so as to reduce as much as possible the pressure between the first face 21 and the cavity 13 and to facilitate the movement of the injected material, which covers the first surface 21. It is thus possible to reduce the time necessary for the injection step 105 and to avoid premature crosslinking of the injected material. The vacuum drawing step 104 by the vacuum drawing system 4 is carried out after the mold closing step 102, and before or after a possible vacuum drawing step 103 by the vacuum pump 5.

According to one implementation of the method, a step 106 of moving the first face 21 of the vessel 20 away from the female part 12 is implemented either after the opening step 107 or possibly during the opening 107 of the mold 10. The separation 6 is achieved by actuating the pushers 14 disposed in the cavity 13 of the female part 12.

1. A mold for injection overmolding a tableware vessel with a material comprising silicone, the mold comprising a female part and a male part, the female part comprising:
a cavity configured to accommodate a first face of the tableware vessel during overmolding,
an injection nozzle configured to allow the injection of the material comprising silicone into the cavity over the first face,
the male part comprising:
a central stud formed of a material having a Shore D hardness comprised between 50 and 60 or comprising a coating of a material having a Shore D hardness comprised between 50 and 60, configured to accommodate a second face of the tableware vessel,
a peripheral seal formed of a material having a Shore A hardness comprised between 50 and 60, and configured to accommodate edges of the tableware vessel, the peripheral seal extending circumferentially around the central stud,
a shaping recess that extends circumferentially between the central stud and the peripheral seal,
wherein the shaping recess and the peripheral seal are suitable for allowing the edges to move during overmolding.

2. The mold according to claim 1, further comprising a vacuum pump connected to a central orifice opening into a central zone of the stud so as to retain the second face on the central stud by suction.

3. The mold according to claim 1, further comprising a vacuum drawing system opening out into the female part facing the first face or facing the male part.

4. The mold according to claim 1, wherein the peripheral seal and/or the central stud comprise a material having nonstick properties or being covered with a coating comprising a material having nonstick properties.

5. The mold according to claim 1, wherein the peripheral seal and/or the shaping recess is/are adapted to allow the edges to move by less than 3 millimeters.

6. The mold according to claim 1, further comprising at least one pusher located in the cavity of the female part and capable of moving the vessel away from the cavity by pushing on the first face.

7. The mold according to claim 6, said at least one pusher extending over the entire circumference of the cavity.

8. A method of overmolding a tableware vessel with a material comprising silicone, comprising steps of:
a. positioning the vessel in a mold according to claim 1, a second face of the vessel being placed on the central stud and the edges of the vessel being accommodated on the peripheral seal,
b. closing the mold by bringing the female part opposite the male part so as to retain the vessel between the female part and the male part,
c. injecting the material comprising silicone through the injection nozzle until the first face is covered with the material,
d. opening the mold and removing the vessel.

9. The overmolding method according to claim 8, further comprising a step of drawing a vacuum in the air located between the second face and the central stud by means of a vacuum pump connected to a central orifice opening into a central zone of the stud, so as to retain the second face of the vessel on the central stud.

10. The overmolding method according to claim 8, further comprising a step of drawing a vacuum in the air disposed between the first face and the cavity by means of a vacuum drawing system so as to facilitate the injection of the material comprising silicone into the cavity.

11. The overmolding method according to claim 8, comprising, before or during the step of opening the mold, a step of moving the first face of the vessel away from the female part, implemented by actuating pushers located in the cavity of the female part.

12. The overmolding method according to claim 8, wherein the tableware vessel is a tempered glass vessel.

13. The overmolding method according to claim 10, the vessel being a plate or a ramekin.

14. The mold according to claim 4, wherein the material having nonstick properties is polytetrafluoroethylene.

15. The mold according to claim 5, wherein the peripheral seal and/or the shaping recess is/are adapted to allow the edges to move by between 1 and 2 millimeters.
